(19) United States
(12) Patent Application Publication
(10) Pub. No.: US 2023/0117012 A1
(43) Pub. Date: Apr. 20, 2023

(54) METHOD AND SYSTEM FOR GENERATING APPROVAL PREDICTIONS FOR FINANCIAL SERVICE REQUESTS

(71) Applicant: Dell Products L.P., Round Rock, TX (US)

(72) Inventors: Mayank Gupta, Ghaziabad (IN); Sumant Sahoo, Bengaluru (IN); Ramakanth Kanagovi, Bengaluru (IN); Sivaram L, Bangalore (IN); Disha Jain, Agra (IN); Kaivan Ketan Shah, Mumbai (IN)

(21) Appl. No.: 17/506,488

(22) Filed: Oct. 20, 2021

(51) Int. Cl. G06Q 30/00; G06Q 30/02; G06N 20/00

(52) U.S. Cl. CPC G06Q 30/016; G06Q 30/0202; G06N 20/00

(57) ABSTRACT

Techniques described herein relate to a method for managing financial service requests. The method includes obtaining, by a prediction manager, a financial service request (FSR) from a client; obtaining historical information associated with the FSR; generating prediction model inputs using the FSR and the historical information; identifying FSR agent comments associated with the FSR; generating a request vector using the FSR agent comments; generating an FSR authenticity index using the request vector and the prediction model inputs; applying a first machine learning model to the FSR authenticity index and the prediction model inputs to generate a first prediction; providing the first prediction to a first approver; and obtaining first approver comments from the first approver.

### BACKGROUND

Computing devices may provide services. The computing devices may include hardware components and software components. The hardware components and/or the software components of the computing devices may fail for whatever reason, resulting in the failure of the computing devices. The user of the computing devices may desire financial compensation for the failure of the computing device. The user may submit a request for financial compensation to a manufacturer of the computing device. An approver of the manufacturer may approve or deny the request for financial compensation.

### SUMMARY

In general, certain embodiments described herein relate to a method for managing financial service requests. The method may include obtaining, by a prediction manager, a financial service request (FSR) from a client; obtaining historical information associated with the FSR; generating prediction model inputs using the FSR and the historical information; identifying FSR agent comments associated with the FSR; generating a request vector using the FSR agent comments; generating an FSR authenticity index using the request vector and the prediction model inputs; applying a first machine learning model to the FSR authenticity index and the prediction model inputs to generate a first prediction; providing the first prediction to a first approver; and obtaining first approver comments from the first approver.

In general, certain embodiments described herein relate to a non-transitory computer readable medium that includes computer readable program code, which when executed by a computer processor enables the computer processor to perform a method for managing financial service requests. The method may include obtaining, by a prediction manager, a financial service request (FSR) from a client; obtaining historical information associated with the FSR; generating prediction model inputs using the FSR and the historical information; identifying FSR agent comments associated with the FSR; generating a request vector using the FSR agent comments; generating an FSR authenticity index using the request vector and the prediction model inputs; applying a first machine learning model to the FSR authenticity index and the prediction model inputs to generate a first prediction; providing the first prediction to a first approver; and obtaining first approver comments from the first approver.

In general, certain embodiments described herein relate to a system for managing financial service requests. The system includes a client and a prediction manager. The prediction manager includes a processor and memory, and is programmed to obtain a financial service request (FSR) from the client; obtain historical information associated with the FSR; generate prediction model inputs using the FSR and the historical information; identify FSR agent comments associated with the FSR; generate a request vector using the FSR agent comments; generate an FSR authenticity index using the request vector and the prediction model inputs; apply a first machine learning model to the FSR authenticity index and the prediction model inputs to generate a first prediction; provide the first prediction to a first approver; and obtain first approver comments from the first approver.

Other aspects of the embodiments disclosed herein will be apparent from the following description and the appended claims.

### BRIEF DESCRIPTION OF DRAWINGS

Certain embodiments will be described with reference to the accompanying drawings. However, the accompanying drawings illustrate only certain aspects or implementations by way of example and are not meant to limit the scope of the claims.

FIG. 1 shows a diagram of a system in accordance with one or more embodiments.

FIGS. 2A-2C show flowcharts of a method for generating approval predictions for financial service requests in accordance with one or more embodiments.

FIG. 3 shows a diagram of an example in accordance with one or more embodiments.

FIG. 4 shows a diagram of a computing device in accordance with one or more embodiments.

### DETAILED DESCRIPTION

Specific embodiments will now be described with reference to the accompanying figures. In the following description, numerous details are set forth as examples. It will be understood by those skilled in the art that one or more embodiments may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In general embodiments relate to systems, methods, and non-transitory computer readable mediums for managing financial service requests. Managing financial service requests may include generating approval predictions associated with the financial service request.

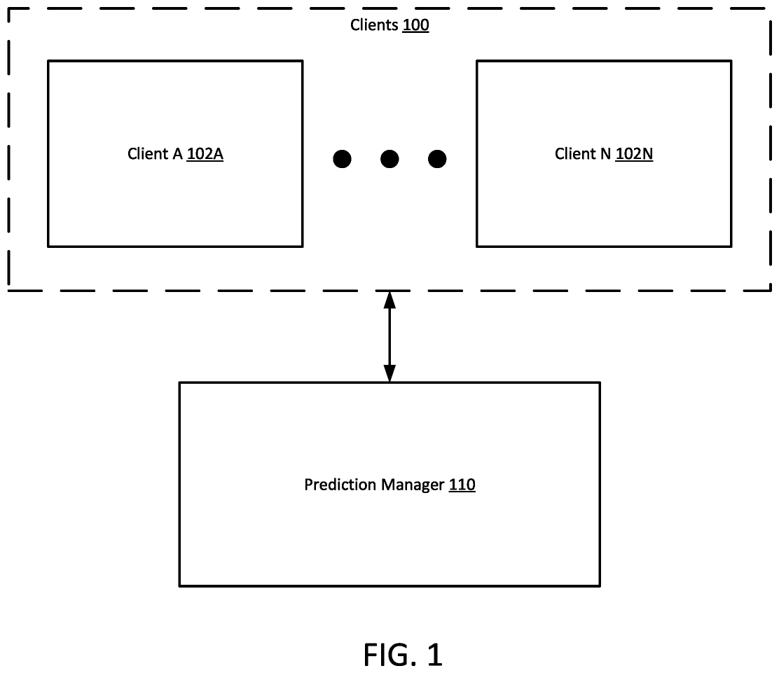

FIG. 1 shows a diagram of a system in accordance with one or more embodiments. The system may include clients (100) and a prediction manager (110). The system may include other and/or additional devices and/or components without departing from the scope of the embodiments disclosed herein. The devices and components of the system illustrated in FIG. 1 may be operatively connected via any combinations of wired (e.g., Ethernet) and/or wireless (e.g., WAN) connections without departing from the scope of the embodiments disclosed herein. Each of the aforementioned components of the system in FIG. 1 is discussed below.

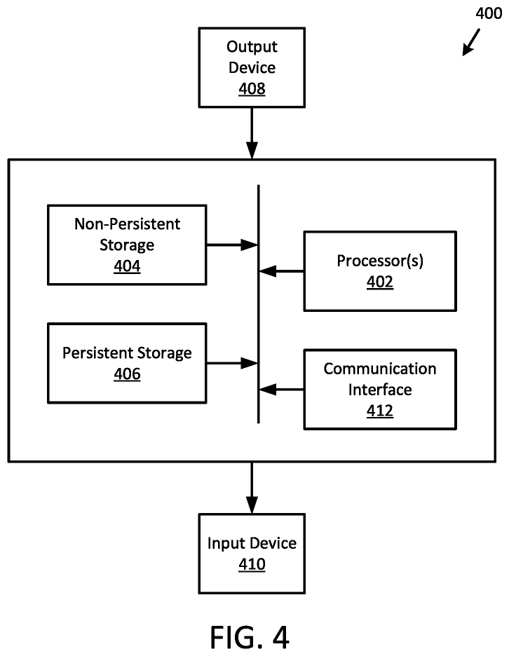

In one or more embodiments, the clients (100) are implemented as one or more computing devices. In one or more embodiments, a computing device is any device, portion of a device, or any set of devices capable of electronically processing instructions and may include any number of components, which include, but are not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), accelerators (e.g., GPUs) (not shown), sensors (not shown) for obtaining data, and/or any combination thereof. For additional information regarding computing devices, refer to FIG. 4.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre/fiber channel storage device, an Internet Small Computer Systems Interface (iSCSI) storage device, a tape storage device, a flash storage array, a network attached storage device, etc.), a network device (e.g., switch, router, multi-layer switch, etc.), a hyperconverged infrastructure, a cluster, a virtual machine, a logical container (e.g., for one or more applications), and/or any other type of device with the aforementioned requirements.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums, which may store software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform, when executed, methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

In one or more embodiments, the clients (100) include the functionality to perform computer implemented services. The computer implemented services may include, for example, database services, electronic communication services, inferencing services, calendar services, etc. The computer implemented services may include other and/or additional types of services without departing from the scope of the embodiments disclosed herein. The clients (100) may perform any one or any combination of the aforementioned types of computer implemented services without departing from the scope of the embodiments disclosed herein. The clients (100) may include one or more clients (100) without departing from the scope of the embodiments disclosed herein. For example, the clients (100) may include client A (102A) and client N (102N). Each client (e.g., 102A) may perform the same and/or different computer implemented services as other clients (e.g., 102N). The clients (100) may include other and/or additional functionalities without departing from the scope of the embodiments disclosed herein.

In one or more embodiments, to perform the computer implemented services, a client (e.g., 102A) includes hardware components and/or software components. The hardware components may include computing devices and/or components of computing devices (e.g., refer to the above discussion regarding computing devices). The computing devices may include, for example, laptop computers, desktop computers, servers, mobile phones, etc. The computing devices may include other and/or additional types of computing devices without departing from the scope of the embodiments disclosed herein. The computing device components may include, for example, central processing units (CPUs), graphics processing units (GPUs), storage devices (e.g., hard disk drives, RAM, solid-state drives, etc.), power supplies, server chassis, batteries, etc. The computing device components may include other and/or additional types of computing device components without departing from the scope of the embodiments disclosed herein. The software components may include, for example, operating systems, applications, containers, etc. The software components may be may be implemented as computer instructions, e.g., computer code, stored on a storage of a client (e.g., 102A) that when executed by a processor(s) of the client (e.g., 102A) cause the client (e.g., 102A) to provide the functionality of the software components. The software components may include other types of software components without departing from the scope of the embodiments disclosed herein.

In one or more embodiments, a user of a client (e.g., 102A) orders and purchases all, or a portion, of the hardware components and the software components from a manufacturer or a third party seller. The user may be, for example, a single customer or an organization (e.g., a company, a government, etc.). The hardware components and/or the software components may fail or otherwise experience issues. Such failures and/or issues may include, for example, physical failures (e.g., dents, chips, or other imperfections on the hardware components), computer freezes, communication errors, power failures, performance issues, booting issues, shipping issues, etc. The failures and/or issues may include other and/or additional types of failures and/or issues without departing from the scope of the embodiments disclosed herein. The failures and/or issues may occur after a client has obtained the hardware component or software component (e.g., during use) or before a client has obtained the hardware component or software component (e.g., during shipping, manufacturing, etc.). The failures and/or issues may occur for any reason (e.g., user error, faulty component, software bugs, etc.) without departing from the scope of the embodiments disclosed herein.

The user of a client (e.g., 102A) that experiences a failure or an issue may desire and be entitled to financial compensation for the failure or issues from the entity or entities (e.g., one or more manufacturers, third party sellers, etc.) that provided the hardware component and/or software components that are associated with the failure or issue. To receive financial compensation, the user of the client (e.g., 102A) that experienced the failure or issue may generate and submit a financial service request (FSR) to the manufacturer, the third party seller, and/or an independent reviewer associated with the hardware component and/or software component that experienced the failure or issue. A user of the manufacturer, third party seller, and/or an independent reviewer (i.e., an approver) may determine whether to approve or deny the FSR. To efficiently determine whether to approve or deny an FSR, the manufacturer, third party seller, and/or independent reviewer may use a prediction manager (110) to generate FSR approval predictions.

An FSR may be one or more data structures that include FSR information. The FSR information may include, for example, a user identifier (e.g., a unique string or combination of bits associated with a particular user), an FSR type, the hardware components and/or software components associated with the FSR, a geographic location associated with the user (e.g., country), quantity of hardware components and/or software components associated with the FSR, FSR agent comments (discussed below), compensation amount, etc. The FSR information may include other and/or additional information associated with the FSR, the user that submitted the FSR, and/or the hardware components and/or software components associated with the FSR. The FSR may be generated by the user and/or an FSR agent (discussed below). The FSR may be used by the prediction manager (110) to generate FSR approval predictions.

In one or more embodiments, the prediction manager (110) is implemented as one or more computing devices. The computing devices may be embodiments of the computing device discussed above.

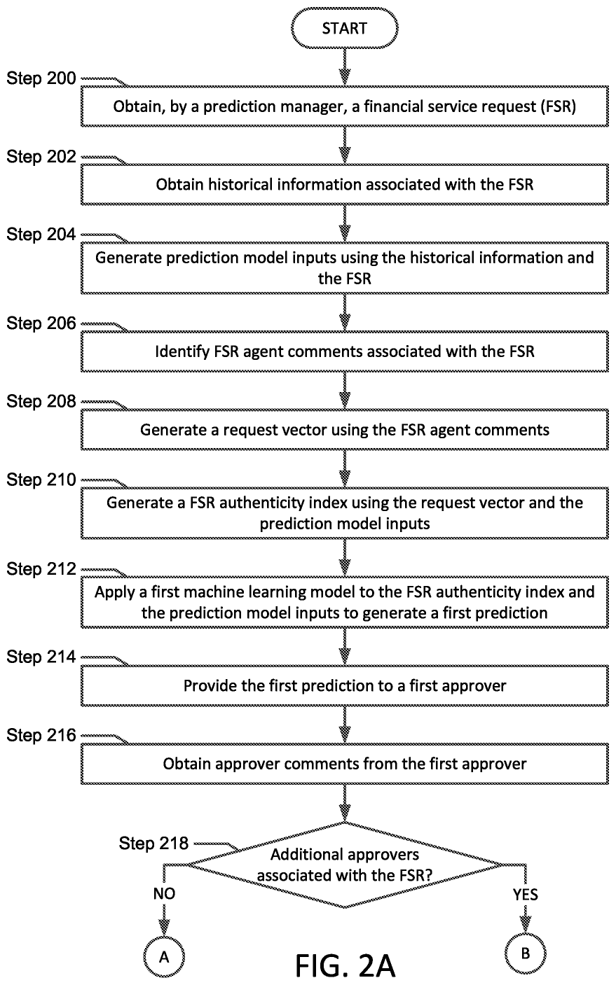

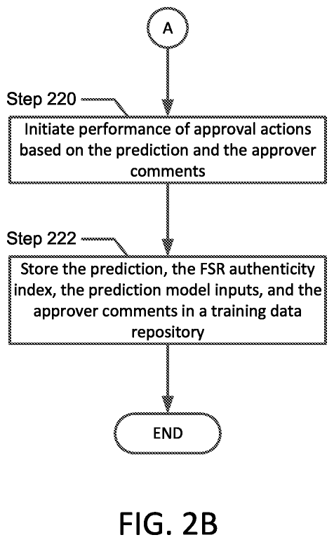

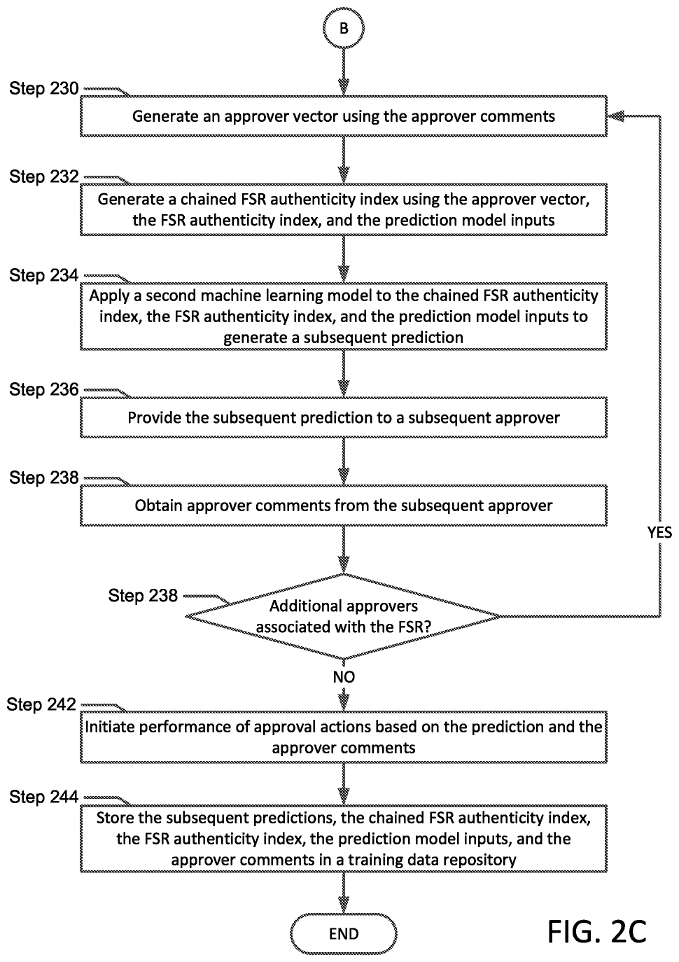

In one or more embodiments, the prediction manager (110) includes the functionality to generate FSR approval predictions. To generate FSR approval predictions, the prediction manager may provide and/or obtain information (e.g., FSRs, user identifiers, etc.) to and/or from the clients (100) and/or other entities not illustrated in the system of FIG. 1. Such entities may include, for example, user history managers which may maintain historical information (discussed below) associated with users of the clients (100). For additional information regarding generating FSR approval predictions, refer to FIGS. 2A-2C. The prediction manager (100) may include other and/or additional functionalities without departing from the scope of the embodiments disclosed herein.

FIGS. 2A-2C show flowcharts of a method for generating approval predictions for financial service requests in accordance with one or more embodiments. The method depicted in FIGS. 2A-2C may be performed by a prediction manager (110, FIG. 1). All, or a portion, of the method of FIGS. 2A-2C may be performed by other components discussed throughout this Detailed Description without departing from the scope of the embodiments disclosed herein.

While the various steps in the flowcharts shown in FIGS. 2A-2C are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

Turning to FIG. 2A, in Step 200, a financial service request (FSR) is obtained by a prediction manager.

In one or more embodiments, a hardware component or software component of a client fails or otherwise experiences an issue. The user of the client may generate the FSR. As discussed above, the FSR may include FSR information associated with the FSR. The user may then provide the FSR to an FSR agent (not shown in the system of FIG. 1). The FSR agent may update the FSR to include FSR agent comments (discussed below) associated with the FSR. The FSR agent may be, for example, a sales representative associated with the manufacturer or third party seller which provided the hardware components and/or software components associated with the FSR. In another embodiment, the user may initiate the generation of the FSR by instructing an FSR agent to generate the FSR. The FSR agent may locally generate or update the FSR using the client, or the FSR agent may remotely generate the FSR using other computing devices not illustrated in the system of FIG. 1. The FSR agent or the user of the client may provide the FSR to the prediction manager using any appropriate method of data transmission without departing from the scope of the embodiments disclosed herein. As an example, the user or the FSR agent may transmit the FSR as network data traffic units over a series of network devices that operatively connect to the user of the client or the FSR agent to the prediction manager. The FSR may be obtained by the prediction manager via other and/or additional methods without departing from the scope of the embodiments disclosed herein.

In Step 202, historical information associated with the FSR is obtained.

In one or more embodiments, the prediction manager requests and obtains historical information associated with the FSR from an entity not illustrated in the system of FIG. 1. The entity may be a user history manager. The user history manager may be one or more computing devices that include the functionality to maintain historical information associated with users of the clients. The user history manager may be used by the manufacturer or third party seller of the hardware components and/or software components purchased by the users of the clients. The prediction manager may send a request to the user history manager to obtain historical information associated with the user that submitted the FSR. The request may include, for example, the user identifier associated with the user that submitted the FSR. The request may include other and/or additional information associated with the user or the FSR without departing from the scope of the embodiments disclosed herein. In response to obtaining the request, the user history manager may obtain and provide the history information associated with the FSR to the prediction manager. The request and the historical information may be shared between the prediction manager and the user history manager using any appropriate method of data transmission without departing from the scope of the embodiments disclosed herein. As an example, the prediction manager may transmit the request for historical information associated with the FSR as network data traffic units over a series of network devices that operatively connect to the prediction manager to the user history manager. Historical information associated with the FSR may be obtained via other and/or additional methods without departing from the scope of the embodiments disclosed herein.

Historical information may be one or more data structures that specify order information and customer information associated with the user of the FSR. The historical information may include, for example, previous orders, submission and delivery timestamps associated with previous orders and order associated with FSR, monetary value associated with each order, margins (i.e., profit associated with each order), hardware components and/or software components associated with each order, overall monetary size of the orders of the user, the budget of the user, quantity of late orders, known expenses associated with the user, quantity of contacts (i.e., amount of times user has contacted the manufacturer), quantity of trips made by sales representative and account executives (i.e., senior level sales representatives) to the user, quantity of reissued orders due to failure or other issue, quantity of hardware components and/or software components for which an FSR may be submitted by the user, and one or more customer satisfaction scores submitted by the user. The historical information may include other and/or additional information associated with the user that submitted the FSR without departing from the scope of the embodiments disclosed herein. The historical information may be used by the prediction manager to generate prediction model inputs (discussed below).

In Step 204, prediction model inputs are generated using the historical information and the FSR.

In one or more embodiments, the prediction manager uses the FSR and the historical information to generate the prediction model inputs. The prediction model inputs may be one or more data structures that include an account profiling index, an order lifecycle index, and an experience index. The prediction manager may generate the account profiling index, the order lifecycle index, and the experience index using the historical information and/or the FSR. The prediction model inputs may also include FSR features which may be generated using FSR information extracted and/or transformed from the FSR. The prediction model inputs may be generated using the historical information and the FSR via other and/or additional methods without departing from the scope of the embodiments disclosed herein.

In one or more embodiments, the account profiling index is a number between zero and one that denotes the type of account associated with the user that submitted the FSR based on previous purchase patterns and behavior. If the account profiling index is closer to one, then it implies that the user associated with the FSR is a regular purchaser of products from the manufacturer. Accordingly, FSRs submitted by such users may be more likely to be genuine. Therefore, such FSRs may be more likely to be approved.

In one or more embodiments, the account profiling index may be generated by calculating an account profiling score. The account score may be the product of a recency score, a frequency score, a monetary score, trend of revenue unit and margins (RUM), account line of balance, addressable market opportunity, and a share of wallet.

The recency score may denote how recent the last order (i.e., purchase) by the user was made. The date of the last purchase may be specified by the historical information associated with the user. The recency score may split the date of last purchase into three different ranges. A first range may represent the most recent range of dates for last purchase and may be assigned a recency score of three. A second range may represent the medium recent range of dates for last purchase and may be assigned a recency score of two. A third range may represent the oldest range of dates for last purchase and may be assigned a recency score of one.

The frequency score may denote the number of purchases made by the user in the past year. The number of purchases in the past year may be specified by the historical information associated with the user. The frequency score may split the number of purchases made by the user in the last year into three different ranges. A first range may represent the most amount of purchases and may be assigned a frequency score of three. A second range may represent a medium amount of purchases and may be assigned a frequency score of two. A third range may represent the fewest amount of purchases and may be assigned a frequency score of one.

The monetary score may denote the average monetary amount of each purchase made by the user in the past year. The average monetary amount of each purchase made by the user in the past year may be specified by the historical information associated with the user. The monetary score may split the average monetary amount of each purchase made by the user in the last year into three different ranges. A first range may represent the highest average monetary amount of each purchase and may be assigned a monetary score of three. A second range may represent a medium average monetary amount of each purchase and may be assigned a monetary score of two. A third range may represent the lowest average monetary amount of each purchase and may be assigned a monetary score of one.

The trend of RUM may denote whether the revenue, units of purchase, and margins associated with the user have increased, decreased, or remained constant over the history of purchases associated with user. The trend of RUM may be generated by calculating the slope of number of items purchased over time using the historical information associated with the user. A higher slope indicates that the user is purchasing more items and therefore is associated with increasing revenue, units of purchase, and margins. The trend of RUM may split the slope calculations into three different ranges. A first range of slopes may represent the high positive slopes and may be assigned a trend of RUM of three. A second range of slopes may represent a constant slope and may be assigned a trend of RUM of two. A third range of slopes may represent high negative slopes and may be assigned a trend of RUM of one.

The account line of business may denote a preference of the line of business (i.e., particular hardware components and/or software components) of the user based on the previous purchases. A proportion of the line of business may be calculated that may specify how much of the purchases by the user are related to the hardware component or software component specified by the FSR. The proportion may be calculated using the historical information associated with the user. The account line of business may be split into three ranges of proportions of the line of business. A first range of proportions may represent high proportions of the line of business and may be assigned an account line of business of three. A second range of proportions may represent medium proportions of line of business and may be assigned an account line of business of two. A third range of proportions may represent low proportions of line of business and may be assigned an account line of business of one.

The addressable market opportunity may represent the size of the account and the budget associated with the user. The size of the account and the budget may be specified by the historical information associated with the user. The addressable market opportunity may be split into three ranges of budget. A first range of budgets may be associated with high addressable market opportunity and may be assigned an addressable market opportunity of three. A second range of budgets may be associated with a medium addressable market opportunity and may be assigned an addressable market opportunity of two. A third range of budgets may be associated with a low addressable market opportunity and may be assigned an addressable market opportunity of one.

The share of wallet may denote the percentage of addressable market opportunity covered by the user of the prediction manager (i.e., the manufacturer of the hardware components and/or software components). The share of wallet may be generated using information specified by the historical information associated with the user. The share of wallet may be split into three ranges. A first range of percentages of addressable market opportunity may be high shares of wallet and may be assigned a share of wallet of three. A second range of percentages of addressable market opportunity may be medium shares of wallet and may be assigned a share of wallet of two. A third range of percentages of addressable market opportunity may be low shares of wallet and may be assigned a share of wallet of one.

An account profiling score may be calculated by multiplying the assigned recency score, frequency score, monetary score, trend of RUM, account line of business, addressable market opportunity, and share of wallet and then normalized (using a minimum account profiling score and a maximum account profiling score) to generate the account profiling index. The account profiling index may be generated via other and/or additional methods without departing from the scope of the embodiments disclosed herein.

In one or more embodiments, the order lifecycle index number between zero and one that represents the health of the order associated with the FSR. It may be calculated using delivery durations, number of late orders, order late (i.e., whether the order associated with the FSR was late), number of contact cases with customer service, and/or additional types of information included in historical information associated with the user. A high order lifecycle may indicate that the order associated with the financial service request was completed with no issues.

The delivery duration, number of late orders, and number of contact cases with customer service may each be split into three ranges and assigned a value. A first range of delivery durations, number of late orders, and number of contact cases may be low delivery durations, number of late orders, and number of contact cases and may each be assigned a delivery durations, number of late orders, and number of contact cases of three. A second range of delivery durations, number of late orders, and number of contact cases may be medium delivery durations, number of late orders, and number of contact cases and may be assigned a delivery durations, number of late orders, and number of contact cases of two. A third range of delivery durations, number of late orders, and number of contact cases may be high delivery durations, number of late orders, and number of contact cases and may be assigned a delivery durations, number of late orders, and number of contact cases of one.

Additionally, if the order associated with the FSR is late, the order late metric may be assigned a value of one. Similarly, if the order associated with the FSR is not late, the order late metric may be assigned a value of two.

An order lifecycle score may be calculated by multiplying the assigned values for order late, delivery durations, number of late orders, and number of contact cases and then normalized (using a minimum order lifecycle score and a maximum order lifecycle score) to generate the order lifecycle index. The order lifecycle index associated with the FSR may be generated via other and/or additional methods without departing from the scope of the embodiments disclosed herein.

In one or more embodiments, the experience index is a number between one and zero that represents the customer experience of the user associated with the FSR. The experience index may be generated using the number of trips made by sales representatives to the user, proportion of trips made by sales representative with account executive, the repeat dispatches (i.e., number of hardware components and/or software components that have been replaced in previous orders), the average serviceable units (i.e., number of hardware components and/or software components which are eligible for FSRs), customer satisfaction scores, and other and/or additional information associated with the past experiences of the user that submitted the FSR request specified by the historical information associated with the user. A higher experience index may indicate the user has been highly satisfied with previous interactions with the manufacturer and may then increase the likelihood that the FSR is genuine.

The number of trips made by sales representatives to the user, proportion of trips made by sales representative with account executive, repeat dispatches, average serviceable units, and customer satisfaction scores may each be split into three ranges and assigned a value. A first range of number of trips made by sales representatives to the user, proportion of trips made by sales representative with account executive, repeat dispatches, average serviceable units, and customer satisfaction scores may be high number of trips made by sales representatives to the user, proportion of trips made by sales representative with account executive, repeat dispatches, average serviceable units, and customer satisfaction scores and may each be assigned a value of three. A second range of number of trips made by sales representatives to the user, proportion of trips made by sales representative with account executive, repeat dispatches, average serviceable units, and customer satisfaction scores may be medium number of trips made by sales representatives to the user, proportion of trips made by sales representative with account executive, repeat dispatches, average serviceable units, and customer satisfaction scores and may each be assigned a value of two. A third range of number of trips made by sales representatives to the user, proportion of trips made by sales representative with account executive, repeat dispatches, average serviceable units, and customer satisfaction scores may be low number of trips made by sales representatives to the user, proportion of trips made by sales representative with account executive, repeat dispatches, average serviceable units, and customer satisfaction scores and may each be assigned a value of one.

An experience score may be calculated by multiplying the assigned values for number of trips made by sales representatives to the user, proportion of trips made by sales representative with account executive, repeat dispatches, average serviceable units, and customer satisfaction scores and then normalized (using a minimum experience score and a maximum experience score) to generate the order lifecycle index. The experience index associated with the FSR may be generated via other and/or additional methods without departing from the scope of the embodiments disclosed herein.

In Step 206, FSR agent comments associated with the FSR may be identified.

As discussed above, the FSR agent may include FSR agent comments in the FSR. The FSR agent comments may be included in any portion of the FSR without departing from the scope of the embodiments disclosed herein. The FSR agent comments may be included in an attachment (e.g., a separate file included with the FSR) or may be included in a particular field or set of pages designated for FSR agent comments. The prediction manager may identify the FSR agent comments by checking the attachment, the field, or set of pages associated with the FSR agent comments. The FSR agent comments associated with the FSR may be identified via other and/or additional methods without departing from the scope of the embodiments disclosed herein.

The FSR agent comments may be one or more data structures or portions of data structures (e.g., FSRs) that include the description of the reason as to why the user generated the FSR. The description may include, but not be limited to, the hardware component and/or software component associated with the FSR, the failure and/or issue associated with the hardware component and/or software component, the order history associated with the hardware component and/or software component, the customer satisfaction associated with user, and other and/or additional information as to why the user submitted the FSR. The FSR agent comments may include other and/or additional information without departing from the scope of the embodiments disclosed herein. The FSR agent comments may be used to generate a request vector as discussed below.

In Step 208, a request vector is generated using the FSR agent comments.

In one or more embodiments, the prediction manager generates the request vector using the FSR agent comments. The prediction manager may generate the request vector using any appropriate method for translating or otherwise representing text-based data as a vector without departing from the scope of the embodiments disclosed herein. As an example, the prediction manager may include a Doc2Vec model that represents the requestor comments in a 200 dimensional vector space using paragraph embedding. The prediction manager may further use singular value decomposition to represent the request vector in the same dimension as the prediction model inputs. The request vector may be generated using the FSR agent comments via other and/or additional methods without departing from the scope of the embodiments disclosed herein.

In Step 210, an FSR authenticity index is generated using the request vector and the prediction model inputs.

In one or more embodiments, the prediction manager generates the FSR authenticity index using the request vector and the prediction model inputs. The FSR authenticity index may be generated by calculating the similarity between the request vector and the prediction model inputs. The similarity between the request vector and the prediction model inputs may be calculated using any appropriate method for determining the similarity between two vectors without departing from the scope of the embodiments disclosed herein. For example, the prediction manager may generate the FSR authenticity index by calculating the Euclidean distance between the request vector and the prediction model inputs. As another example, the prediction manager may generate the FSR authenticity index by calculating the cosine similarity between the request vector and the prediction model inputs. As a result, the FSR authenticity index may be a value that denotes the similarity between the request vector and the prediction model inputs. In other words, the FSR authenticity index may specify how similar the FSR agent comments are to the FSR and the historical information associated with the FSR. A higher similarity between the FSR agent comments and the FSR and historical information associated with the FSR may result in a higher probability of approval for the FSR. The FSR authenticity index may be generated using the request vector and the prediction model inputs via other and/or additional methods without departing from the scope of the embodiments disclosed herein.

In Step 212, a first machine learning model is applied to the FSR authenticity index and the prediction model inputs to generate a first prediction.

In one or more embodiments, the prediction manager applies a first machine learning model to the FSR authenticity index and the prediction model inputs to generate a first prediction. The first prediction model may include any appropriate machine learning model for generating approval predictions for FSRs using the prediction model inputs and the FSR authenticity index. The first prediction model may include, for example, one or more random forest machine learning models, neural network models, extreme gradient booting models, light gradient boosting models, and/or other and/or additional types of machine learning models without departing from the scope of the embodiments disclosed herein. The first machine learning model may include any combination of the aforementioned machine learning models without departing from the scope of the embodiments disclosed herein. The prediction manager may input the FSR authenticity index and the prediction model inputs into the first prediction model to generate the approval prediction. The approval prediction may include a probability that the FSR is to be approved. The probability may include, for example, a percentage that the FSR is to be approved. The first machine learning model may be applied to the FSR authenticity index and the prediction model inputs to generate a first prediction via other and/or additional methods without departing from the scope of the embodiments disclosed herein.

To generate the first machine learning model, the prediction manager may use an automated machine learning (AutoML) algorithm and training data. The AutoML algorithm may include, for example, Tree-Based Pipeline Optimization Tool (TPOT). Other types of AutoML algorithms may be used without departing from the scope of the embodiments disclosed herein. The AutoML algorithm may perform data cleaning, feature selection, feature preprocessing, and feature construction using the training data (e.g., to generate prediction model inputs and FSR authenticity index). Based on the feature selection, feature preprocessing, and feature construction, the AutoML algorithm may select and train the first machine learning model using the training data and one or more machine learning algorithms (e.g., a random forest machine learning algorithm, neural network algorithms, extreme gradient booting algorithms, light gradient boosting model algorithms, etc.) based on model performance with the training data. After selecting the first machine learning model, the AutoML algorithm may perform parameter optimization and model validation using the training data and the first machine learning model to finalize the first machine learning model. The first machine learning model may be generated via other and/or additional methods without departing from the scope of the embodiments disclosed herein.

In one or more embodiments, the training data may be one or more data structures that include previously submitted FSRs. The previously submitted FSRs may include FSR information and FSR agent comments associated with the previous FSRs. The training data may include any number of previous FSRs without departing from the scope of the embodiments disclosed herein. The training data may be included in the training data repository (e.g., a collection of previously submitted FSRs). The training data repository may be stored in a persistent storage device (e.g., hard-disk drive, solid-state drive, etc.) of the prediction manager or a persistent storage device operatively connected to the prediction manager. The prediction manager and/or a user of the system associated with the manufacturer (e.g., an IT administrator, data scientist, etc.) may maintain the training data repository. The training data repository and the training data may include other and/or additional information without departing from the scope of the embodiments disclosed herein.

In Step 214, the first prediction is provided to a first approver.

In one or more embodiments, the prediction manager sends a message to the first approver. The message may include the first prediction. The message may further include a copy of the FSR authenticity index, the historical information associated with the user that submitted the FSR, the FSR agent comments, and the FSR associated with the first prediction. The message may be sent to the first approver using any appropriate method of data transmission without departing from the scope of the embodiments disclosed herein. As an example, the message may be sent as electronic mail using electronic mail applications of computing devices (e.g., the prediction manager and a computer of the first approver) connected over a network (e.g., the Internet). The prediction manager may include a list of one or more approvers associated with the user and/or the FSR. Different approvers may be assigned to different users or types of FSRs (e.g., specific hardware component and/or software component associated with the FSRs). The list of approvers may include approver identifiers and contact information (e.g., email address) associated with the approvers. The list of approvers may be generated and provided to the prediction manager by the approvers and/or other users associate with the manufacturer. The first approver may be randomly selected from the list of approvers. The first approver may be selected based on a particular order specified by the list of approvers. The first prediction may be provided to the first approver via other and/or additional methods without departing from the scope of the embodiments disclosed herein.

In Step 216, approver comments are obtained from the first approver.

In one or more embodiments, in response to obtaining the first prediction, the first approver generates approver comments associated with the first prediction. The first approver comments may be one or more data structures that include an indication regarding whether the first approver would approve or deny the FSR and the reasons why the approver would approve or deny the FSR and/or information associated with the FSR. The FSR approver comments may include, for example, the hardware component and/or software component associated with the FSR, the failure and/or issue associated with the hardware component and/or software component, the order history associated with the hardware component and/or software component, the customer satisfaction associated with user, and other and/or additional information as to why the approver would approve or deny the FSR. The first approver may generate the approver comments based on the FSR, the FSR authenticity index, the FSR agent comments, and the historical information associated with the user. The FSR agent comments may include other and/or additional information without departing from the scope of the embodiments disclosed herein. The approver comments may be sent to the prediction manager using any appropriate method of data transmission without departing from the scope of the embodiments disclosed herein. As an example, the approver comments may be sent as electronic mail using electronic mail applications of computing devices (e.g., the prediction manager and a computer of the first approver) connected over a network (e.g., Internet). Approver comments may be obtained via other and/or additional methods without departing from the scope of the embodiments disclosed herein.

In Step 218, a determination is made as to whether additional approvers are associated with the FSR.

As discussed above, the prediction manager may include a list of approvers associated with the FSR and/or the user. The prediction manager may check the list of approvers to identify a second approver identifier associated with a second approver. If the prediction manager identifies a second approver identifier associated with a second approver included in the list of approvers, then the prediction manager may determine that additional approvers are associated with the FSR. If the prediction manager does not identify a second approver identifier associated with a second approver included in the list of approvers, then the prediction manager may determine that no additional approvers are associated with the FSR. The determination as to whether additional approvers are associated with the FSR may be made via other and/or additional methods without departing from the scope of the embodiments disclosed herein.

In one or more embodiments, if it is determined that there are no additional approvers associated with the FSR, then the method proceeds to Step 220 of FIG. 2B. In one or more embodiments, if it is determined that there are additional approvers associated with the FSR, then the method proceeds to Step 230 of FIG. 2C.

Turning to FIG. 2B, in Step 220, performance of approval actions are initiated based on the first prediction and the approver comments.

In one or more embodiments, the prediction manager initiates the performance of approval actions based on the first prediction and the approver comments. The prediction manager may include a list of approval actions. The list of approval actions may be one or more data structures that specify approval actions based on the first prediction and the approver comments. The approval actions may include, for example, initiate the reimbursement of the FSR, send a message to the user notifying the user that the FSR is approved or denied, request additional information from the user, request additional information from the first approver, request the approver to send a message notifying the user that the FSR is approved or denied, and other and/or additional types of actions without departing from the scope of the embodiments disclosed herein. Each approval action included in the list may be associated with a prediction threshold and/or whether the first approver approves and/or denies the FSR. For example, if the prediction is above 95% that the FSR is to be approved, then the prediction manager may initiate the reimbursement of the FSR and notify the user that the FSR is approved. The performance of approval actions may be initiated based on the first prediction and the approver comments via other and/or additional methods without departing from the scope of the embodiments disclosed herein.

In Step 222, the prediction, the FSR authenticity index, the prediction model inputs, and the approver comments are stored in a training data repository.

In one or more embodiments, the prediction manager stores the FSR authenticity index, the prediction model inputs, the first prediction, and the approver comments in the training data repository. The prediction manager may also store the FSR and the historical information in the training data repository. The prediction manager may update the training data repository to include the FSR authenticity index, the prediction model inputs, the first prediction, the approver comments, the FSR, and the historical information associated with the FSR. As a result, the prediction, the FSR authenticity index, the prediction model inputs, the approver comments, the FSR, and the historical information associated with the FSR may be used to refine the first machine learning model or to generate another first machine learning model to improve the performance of the first machine learning model. The prediction, the FSR authenticity index, the prediction model inputs, and the approver comments may be stored in the training data repository via other and/or additional methods without departing from the scope of the embodiments disclosed herein.

In one or more embodiments, the method ends following step 222.

Turning to FIG. 2C, in Step 230, an approver vector is generated using the approver comments.

In one or more embodiments, the prediction manager generates the approver vector using the most approver comments from the most recent previous approver. The prediction manager may generate the approver vector using any appropriate method for translating or otherwise representing text-based data as a vector without departing from the scope of the embodiments disclosed herein. As an example, the prediction manager may include a Doc2Vec model that represents the approver comments in a 200 dimensional vector space using paragraph embedding. The prediction manager may further use singular value decomposition to represent the approver vector in the same dimension as the prediction model inputs plus the FSR authenticity index. The approver vector may be generated using the approver comments via other and/or additional methods without departing from the scope of the embodiments disclosed herein.

In Step 232, a chained FSR authenticity index is generated using the approver vector, the FSR authenticity index, and the prediction model inputs.

In one or more embodiments, the prediction manager generates the chained FSR authenticity index using the approver vector, the FSR authenticity index, and the prediction model inputs. The FSR authenticity index and the prediction model inputs may be merged into a single vector. The chained FSR authenticity index may be generated by calculating the similarity between the approver vector and the prediction model inputs plus the FSR authenticity index. The similarity between the approver vector and the prediction model inputs plus the FSR authenticity index may be calculated using any appropriate method for determining the similarity between two vectors without departing from the scope of the embodiments disclosed herein. For example, the prediction manager may generate the chained FSR authenticity index by calculating the Euclidean distance between the approver vector and the prediction model inputs and FSR authenticity index vector. As another example, the prediction manager may generate the chained FSR authenticity index by calculating the cosine similarity between the approver vector and the prediction model inputs and FSR authenticity index vector. As a result, the chained FSR authenticity index may be a value that denotes the similarity between the approver vector and the prediction model inputs and the FSR authenticity index. In other words, the chained FSR authenticity index may specify how similar the approver comments are to the FSR, the historical information associated with the FSR, and the FSR agent comments. A higher similarity between the approver comments are to the FSR, the historical information associated with the FSR, and the FSR agent comments may result in a higher probability of approval for the FSR. The chained FSR authenticity index may be generated using the request vector and the prediction model inputs via other and/or additional methods without departing from the scope of the embodiments disclosed herein.

In Step 234, a second machine learning model is applied to the chained FSR authenticity index, the FSR authenticity index, and the prediction model inputs to generate a subsequent prediction. The second machine learning model may be applied to the chained FSR authenticity index, the FSR authenticity index, and the prediction model inputs via the methods discussed above in Step 212 of FIG. 2A. The second machine learning model may be generated to include as inputs the prediction model inputs, the FSR authenticity index, and the chained authenticity index to generate a subsequent prediction. The subsequent prediction may be an embodiment of the first prediction discussed above. In scenarios in which additional approvers are associated with the FSR, only the chained FSR authenticity index may be changed to make subsequent prediction, the FSR authenticity index and the prediction model inputs may remain the same for each subsequent prediction.

In Step 236, the subsequent prediction is provided to a subsequent approver.

In one or more embodiments, the prediction manager sends a message to a subsequent approver. The message may include the subsequent prediction. The message may further include a copy of the chained FSR authenticity index, the FSR authenticity index, the historical information associated with the user that submitted the FSR, the FSR agent comments, the approver comments, and the FSR associated with the subsequent prediction. The message may be sent to the subsequent approver using any appropriate method of data transmission without departing from the scope of the embodiments disclosed herein. As an example, the message may be sent as electronic mail using electronic mail applications of computing devices (e.g., the prediction manager and a computer of the first approver) connected over a network (e.g., the Internet). As discussed above, the prediction manager may include a list of one or more approvers associated with the user and/or the FSR. The subsequent approver may be randomly selected from the list of approvers that were not previously selected as to avoid repeating the same approvers. The subsequent approver may be selected based on a particular order specified by the list of approvers. The subsequent prediction may be provided to the subsequent approver via other and/or additional methods without departing from the scope of the embodiments disclosed herein.

In Step 238, approver comments are obtained from the subsequent approver.

In one or more embodiments, in response to obtaining the subsequent prediction, the subsequent approver generates approver comments associated with the subsequent prediction. The subsequent approver comments may be one or more data structures that include an indication regarding whether the subsequent approver would approve or deny the FSR and the reasons why the approver would approve or deny the FSR and/or information associated with the FSR. The FSR approver comments may include, for example, the hardware component and/or software component associated with the FSR, the failure and/or issue associated with the hardware component and/or software component, the order history associated with the hardware component and/or software component, the customer satisfaction associated with user, and other and/or additional information as to why the approver would approve or deny the FSR. The subsequent approver may generate the approver comments based on the FSR, the FSR authenticity index, the FSR agent comments, and the historical information associated with the user. The FSR agent comments may include other and/or additional information without departing from the scope of the embodiments disclosed herein. The approver comments may be sent to the prediction manager using any appropriate method of data transmission without departing from the scope of the embodiments disclosed herein. As an example, the approver comments may be sent as electronic mail using electronic mail applications of computing devices (e.g., the prediction manager and a computer of the subsequent approver) connected over a network (e.g., Internet). Approver comments may be obtained via other and/or additional methods without departing from the scope of the embodiments disclosed herein.

In Step 240, a determination is made as to whether additional approvers are associated with the FSR.

As discussed above, the prediction manager may include a list of approvers associated with the FSR and/or the user. The prediction manager may check the list of approvers to identify a second approver identifier associated with a second approver. If the prediction manager identifies a second approver identifier associated with a second approver included in the list of approvers, then the prediction manager may determine that additional approvers are associated with the FSR. If the prediction manager does not identify a second approver identifier associated with a second approver included in the list of approvers, then the prediction manager may determine that no additional approvers are associated with the FSR. The determination as to whether additional approvers are associated with the FSR may be made via other and/or additional methods without departing from the scope of the embodiments disclosed herein.

In one or more embodiments, if it is determined that there are no additional approvers associated with the FSR, then the method proceeds to Step 242. In one or more embodiments, if it is determined that there are additional approvers associated with the FSR, then the method proceeds to Step 230.

In Step 242, performance of approval actions are initiated based on the prediction and the approver comments.

In one or more embodiments, the prediction manager initiates the performance of approval actions based on the subsequent prediction and the approver comments. The prediction manager may include a list of approval actions. The list of approval actions may be one or more data structures that specify approval actions based on the first prediction and the approver comments. The approval actions may include, for example, initiate the reimbursement of the FSR, send a message to the user notifying the user that the FSR is approved or denied, request additional information from the user, request additional information from the subsequent approver, request the approver to send a message notifying the user that the FSR is approved or denied, and other and/or additional types of actions without departing from the scope of the embodiments disclosed herein. Each approval action included in the list may be associated with a prediction threshold and/or whether the first approver approves and/or denies the FSR. For example, if the prediction is above 95% that the FSR is to be approved, then the prediction manager may initiate the reimbursement of the FSR and notify the user that the FSR is approved. The performance of approval actions may be initiated based on the subsequent prediction and the approver comments via other and/or additional methods without departing from the scope of the embodiments disclosed herein.

In Step 244, the subsequent predictions, the chained FSR authenticity index(es), the FSR authenticity index, the prediction model inputs, and the approver comments are stored in a training data repository.

In one or more embodiments, the prediction manager stores the chained FSR authenticity index, the FSR authenticity index, the prediction model inputs, the prediction (i.e., the first prediction and all subsequent predictions), and the approver comments from all approvers in the training data repository. The prediction manager may also store the FSR and the historical information in the training data repository. The prediction manager may update the training data repository to include the chained FSR authenticity index, the FSR authenticity index, the prediction model inputs, the first prediction, the approver comments, the FSR, and the historical information associated with the FSR. As a result, the subsequent predictions, the chained FSR authenticity index, the FSR authenticity index, the prediction model inputs, the subsequent approver comments, the FSR, and the historical information associated with the FSR may be used to refine the first machine learning model and the second machine learning model or to generate another first machine learning model and second machine learning model to improve the performance of the two models. The predictions, the chained FSR authenticity index, the FSR authenticity index, the prediction model inputs, and the approver comments may be stored in the training data repository via other and/or additional methods without departing from the scope of the embodiments disclosed herein.

In one or more embodiments, the method ends following Step 244.

### Example

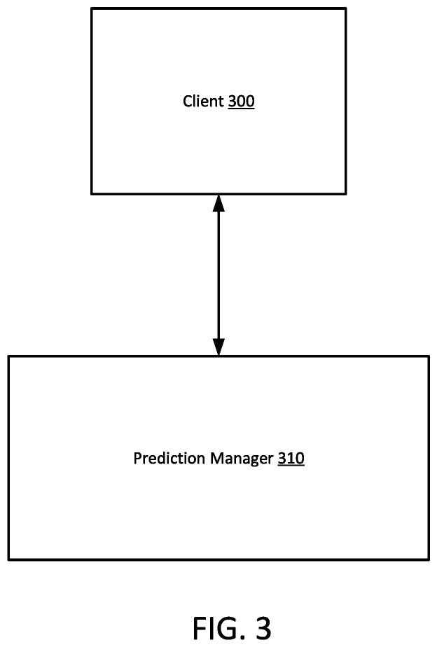

FIG. 3 shows an example in accordance with one or more embodiments described herein. The following example is for explanatory purposes only and not intended to limit the scope of embodiments described herein. Additionally, while the example shows certain aspects of embodiments described herein, all possible aspects of such embodiments may not be illustrated in this particular example. This example is intended to be a simple example to illustrate, at least in part, concepts described herein. One of ordinary skill will appreciate that a real-world use of embodiments described herein may use a device ecosystem organized and interconnected in any manner, and that any number of different workflows to achieve any number of different results may be deployed in such an ecosystem of devices.

Referring to FIG. 3, consider a scenario in which a user of a client (300) is a customer of a company that manufactures laptops. The company uses the prediction manager (310) to generate approval predictions for FSRs associated with laptops manufactured by the company. The user ordered a laptop from the company. When the laptop was delivered to the user of the client (300), the laptop had physical damage to the screen of the laptop that rendered the laptop unusable. As a result of the physical damage of the laptop, the user requests an FSR agent (not shown) associated with the company to generate an FSR associated with the damaged laptop. The FSR agent generates the FSR associated with the laptop and provides the FSR to the prediction manager (300).

In response to obtaining the FSR, the prediction manager (310) requests and obtains historical information associated with the user from a user history manager (not shown). The prediction manager (310) may provide the user identifier included in the FSR to the user history manager to obtain the historical information associated with the user. The historical information includes a complete order history of the user. The prediction manager (310) generates prediction model inputs using the FSR and the historical information associated with the user. The prediction manager (310) extracts FSR features using the FSR and generates an account profiling index, an order lifecycle index, and an experience index using the historical information associated with the user. Each FSR feature as well as the account profiling index, the order lifecycle index, and the experience index are included as a dimension in the vector the represents the prediction model inputs.

The prediction manager (300) then identifies the FSR agent comments included in the FSR and uses the FSR agent comments to generate a request comment vector of the same dimension as the prediction model inputs. The prediction manager (300) uses the request vector and the prediction model inputs to generate an FSR authenticity index associated with the FSR by calculating the similarity between the request vector and the prediction model inputs. The prediction manager (300) generates a first prediction by inputting the FSR authenticity index and the prediction model inputs into a first machine learning model. The first prediction indicates that there is an 80% probability that the FSR should be approved.

After generating the first prediction, the prediction manager (300) provides the first prediction, the FSR, the historical information, the FSR authenticity index, and the prediction model inputs to a first approver of three approvers included in a list of approvers associated with the user. In response to obtaining the first prediction, the FSR, the historical information, the FSR authenticity index, and the prediction model inputs, the first approver generates approver comments using the first prediction, the FSR, the historical information, the FSR authenticity index, and the prediction model inputs. The prediction manager (300) then obtains the approver comments from the first approver. The prediction manager (300) then determines that an additional approver is associated with the FSR.

In response to the determination, the prediction manager (300) then uses the approver comments from the first approver to generate an approver vector of the same dimension as the prediction model inputs plus the FSR authenticity index. The prediction manager (300) uses the approver vector, the FSR authenticity index, and the prediction model inputs to generate a first chained FSR authenticity index associated with the FSR by calculating the similarity between the approver vector and the prediction model inputs plus the FSR authenticity index. The prediction manager (300) then generates a second prediction by inputting the first chained FSR authenticity index, the FSR authenticity index, and the prediction model inputs into a second machine learning model. The second prediction indicates that there is a 90% probability that the FSR should be approved.

After generating the second prediction, the prediction manager (300) provides the second prediction, the FSR, the historical information, the first chained FSR authenticity index, the FSR authenticity index, and the prediction model inputs to a second approver of three approvers included in a list of approvers associated with the user. In response to obtaining the second prediction, the FSR, the historical information, the first chained FSR authenticity index, the FSR authenticity index, and the prediction model inputs, the second approver generates approver comments using the second prediction, the FSR, the historical information, the first chained FSR authenticity index, FSR authenticity index, and the prediction model inputs. The prediction manager (300) then obtains the approver comments from the second approver. The prediction manager (300) then determines that an additional approver is associated with the FSR.

In response to the determination, the prediction manager (300) then uses the approver comments from the first approver to generate an approver vector of the same dimension as the prediction model inputs plus the FSR authenticity index. The prediction manager (300) uses the approver vector, the FSR authenticity index, and the prediction model inputs to generate a first chained FSR authenticity index associated with the FSR by calculating the similarity between the approver vector and the prediction model inputs plus the FSR authenticity index. The prediction manager (300) then generates a second prediction by inputting the first chained FSR authenticity index, the FSR authenticity index, and the prediction model inputs into a second machine learning model. The second prediction indicates that there is a 90% probability that the FSR should be approved.

After generating the second prediction, the prediction manager (300) provides the second prediction, the FSR, the historical information, the first chained FSR authenticity index, the FSR authenticity index, and the prediction model inputs to a second approver of three approvers included in a list of approvers associated with the user. In response to obtaining the second prediction, the FSR, the historical information, the first chained FSR authenticity index, the FSR authenticity index, and the prediction model inputs, the second approver generates approver comments using the second prediction, the FSR, the historical information, the first chained FSR authenticity index, FSR authenticity index, and the prediction model inputs. The prediction manager (300) then obtains the approver comments from the second approver. The prediction manager (300) then determines that an additional approver is associated with the FSR.

In response to the determination, the prediction manager (300) then uses the approver comments from the second approver to generate an approver vector of the same dimension as the prediction model inputs plus the FSR authenticity index. The prediction manager (300) uses the approver vector, the FSR authenticity index, and the prediction model inputs to generate a second chained FSR authenticity index associated with the FSR by calculating the similarity between the approver vector and the prediction model inputs plus the FSR authenticity index. The prediction manager (300) then generates a third prediction by inputting the second chained FSR authenticity index, the FSR authenticity index, and the prediction model inputs into the second machine learning model. The third prediction indicates that there is a 95% probability that the FSR should be approved.

After generating the third prediction, the prediction manager (300) provides the third prediction, the FSR, the historical information, the second chained FSR authenticity index, the FSR authenticity index, and the prediction model inputs to a third approver of three approvers included in a list of approvers associated with the user. In response to obtaining the third prediction, the FSR, the historical information, the second chained FSR authenticity index, the FSR authenticity index, and the prediction model inputs, the third approver generates approver comments using the second prediction, the FSR, the historical information, the second chained FSR authenticity index, FSR authenticity index, and the prediction model inputs. The prediction manager (300) then obtains the approver comments from the third approver. The prediction manager (300) then determines that no additional approver is associated with the FSR.

Based on the third prediction indicating the probability of accepting the FSR is 95%, the prediction manager (300) initiates the performance of an approval action. The approval action is to initiate the reimbursement of the physically damaged laptop to the user and to notify the user that the FSR has been approved. The prediction manager may store the predictions, the approver comments, the chained FSR authenticity indexes, the FSR authenticity index, the prediction model inputs, the FSR, and the historical information associated with the user in the training data repository to update the first machine learning model and the second machine learning model at some point in time in the future.

End of Example

As discussed above, one or more embodiments may be implemented using computing devices. FIG. 4 shows a diagram of a computing device in accordance with one or more embodiments. The computing device (400) may include one or more computer processors (402), non-persistent storage (404) (e.g., volatile memory, such as random access memory (RAM), cache memory), persistent storage (406) (e.g., a hard disk, an optical drive such as a compact disc (CD) drive or digital versatile disc (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Embodiments described herein use a prediction manager to generate approval prediction associated with FSRs. In one or more embodiments, FSRs associated with failed or faulty components may be obtained by a prediction manager. The prediction manager may generate an FSR authenticity index and prediction model inputs using the FSR and historical information associated with the FSR. The FSR authenticity index may specify the similarity between FSR agent comments included in the FSR and the prediction model inputs. The prediction manager may then generate a first prediction using a first machine learning model, the prediction model inputs, and the FSR authenticity index. For scenarios in which the FSR includes multiple approvers, the prediction manager may further generate a chained FSR authenticity index, which may specify the similarity between approver comments and the prediction model inputs plus the FSR authenticity index. Each chained FSR authenticity index, along with the FSR authenticity index and the prediction model inputs, may be input into a second machine learning model to generate improved subsequent approval predictions for the FSR. As a result, accurate approval predictions may be efficiently made for FSRs. Embodiments may mitigate the amount of user involvement in generating FSR approval predictions, thereby further increasing the efficiency of generating the FSR approval predictions as user involvement may be time extensive.

The problems discussed above should be understood as being examples of problems solved by embodiments, and the scope of the embodiments disclosed herein should not be limited to solving the same/similar problems. The disclosed embodiments are broadly applicable to address a range of problems beyond those discussed herein.

While the systems and methods described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing financial service requests, the method comprising:
obtaining, by a prediction manager, a financial service request (FSR) from a client;
obtaining historical information associated with the FSR;
generating prediction model inputs using the FSR and the historical information;
identifying FSR agent comments associated with the FSR;
generating a request vector using the FSR agent comments;
generating an FSR authenticity index using the request vector and the prediction model inputs;
applying a first machine learning model to the FSR authenticity index and the prediction model inputs to generate a first prediction;
providing the first prediction to a first approver; and
obtaining first approver comments from the first approver.

2. The method of claim 1, wherein the first prediction specifies an approval probability associated with the FSR.

3. The method of claim 1, wherein the historical information comprises:
customer information associated with a user of the client; and
order information associated with the FSR.

4. The method of claim 1, wherein the prediction model inputs comprise:
FSR information;
an account profiling index;
an order lifecycle index; and
an experience index.

5. The method of claim 1, wherein the FSR authenticity index specifies a similarity between the request vector and the prediction model inputs.

6. The method of claim 1, the method further comprising:
after obtaining the first approver comments from the first approver:
making a determination that there are no additional approvers associated with the FSR; and
in response to the determination:
initiating performance of approval actions based on the first prediction and the first approver comments; and
storing the first prediction, the FSR authenticity index, the prediction model inputs, and the first approver comments in a training data repository.

7. The method of claim 1, the method further comprising:
after obtaining the first approver comments from the first approver:
making a first determination that there are additional approvers associated with the FSR; and
in response to the first determination:
generating an approver vector using the first approver comments;
generating a chained FSR authenticity index using the approver vector, the FSR authenticity index, and the prediction model inputs;
applying a second machine learning model to the chained FSR authenticity index, the FSR authenticity index and the prediction model inputs to generate a second prediction;
providing the second prediction to a second approver;
obtaining second approver comments from the second approver;
making a second determination that there are no additional approvers associated with the FSR; and
in response to the second determination:
initiating performance of approval actions based on the first prediction, the first approver comments, the second prediction, and the second approver comments; and
storing the first prediction, the second prediction, the chained FSR authenticity index, the FSR authenticity index, the prediction model inputs, the first approver comments, and the second approver comments in a training data repository.

8. The method of claim 7, wherein the chained FSR authenticity index specifies a similarity between:
the approver vector; and
the FSR authenticity index and the prediction model inputs.

9. A non-transitory computer readable medium comprising computer readable program code, which when executed by a computer processor enables the computer processor to perform a method for managing financial service requests, the method comprising:
obtaining, by a prediction manager, a financial service request (FSR) from a client;
obtaining historical information associated with the FSR;
generating prediction model inputs using the FSR and the historical information;
identifying FSR agent comments associated with the FSR;
generating a request vector using the FSR agent comments;
generating an FSR authenticity index using the request vector and the prediction model inputs;
applying a first machine learning model to the FSR authenticity index and the prediction model inputs to generate a first prediction;
providing the first prediction to a first approver; and
obtaining first approver comments from the first approver.

10. The non-transitory computer readable medium of claim 9, wherein the first prediction specifies an approval probability associated with the FSR.

11. The non-transitory computer readable medium of claim 9, wherein the historical information comprises:
customer information associated with a user of the client; and
order information associated with the FSR.

12. The non-transitory computer readable medium of claim 9, wherein the prediction model inputs comprise:
FSR information;
an account profiling index;
an order lifecycle index; and
an experience index.

13. The non-transitory computer readable medium of claim 9, wherein the FSR authenticity index specifies a similarity between the request vector and the prediction model inputs.

14. The non-transitory computer readable medium of claim 9, wherein the method further comprises:
after obtaining the first approver comments from the first approver:
making a determination that there are no additional approvers associated with the FSR; and
in response to the determination:
initiating performance of approval actions based on the first prediction and the first approver comments; and
storing the first prediction, the FSR authenticity index, the prediction model inputs, and the first approver comments in a training data repository.

15. The non-transitory computer readable medium of claim 9, wherein the method further comprises:
after obtaining the first approver comments from the first approver:
making a first determination that there are additional approvers associated with the FSR; and
in response to the first determination:
generating an approver vector using the first approver comments;
generating a chained FSR authenticity index using the approver vector, the FSR authenticity index, and the prediction model inputs;
applying a second machine learning model to the chained FSR authenticity index, the FSR authenticity index and the prediction model inputs to generate a second prediction;
providing the second prediction to a second approver;
obtaining second approver comments from the second approver;
making a second determination that there are no additional approvers associated with the FSR; and
in response to the second determination:
initiating performance of approval actions based on the first prediction, the first approver comments, the second prediction, and the second approver comments; and
storing the first prediction, the second prediction, the chained FSR authenticity index, the FSR authenticity index, the prediction model inputs, the first approver comments, and the second approver comments in a training data repository.

16. The non-transitory computer readable medium of claim 15, wherein the chained FSR authenticity index specifies a similarity between:
the approver vector; and
the FSR authenticity index and the prediction model inputs.

17. A system for managing financial service requests, the system comprising:
a client; and
a prediction manager, comprising a processor and memory, programmed to:
obtain a financial service request (FSR) from the client;
obtain historical information associated with the FSR;
generate prediction model inputs using the FSR and the historical information;
identify FSR agent comments associated with the FSR;
generate a request vector using the FSR agent comments;
generate an FSR authenticity index using the request vector and the prediction model inputs;
apply a first machine learning model to the FSR authenticity index and the prediction model inputs to generate a first prediction;
provide the first prediction to a first approver; and
obtain first approver comments from the first approver.

18. The system of claim 17, wherein the first prediction specifies an approval probability associated with the FSR.

19. The system of claim 17, wherein the historical information comprises:
customer information associated with a user of the client; and
order information associated with the FSR.

20. The system of claim 17, wherein the prediction model inputs comprise:
FSR information;
an account profiling index;
an order lifecycle index; and
an experience index.
